(19) United States
(12) Patent Application Publication
(10) Pub. No.: US 2013/0009391 A1
(43) Pub. Date: Jan. 10, 2013

(54) PERSONAL RESTRAINT SYSTEMS FOR USE IN RECREATIONAL UTILITY VEHICLES AND OTHER VEHICLES

(75) Inventors: Peter E. Miller, Phoenix, AZ (US); Tom Fisher, Burnsville, MN (US); Jeffrey Miller, Cumming, GA (US); Michael A. Wiseman, Elkhart, IN (US); Jeff Wood, Bristol, IN (US); Wayne Carter, Constantine, MI (US); Robert Desmarais, Washington Twp, MI (US)

(73) Assignee: AmSafe Commercial Products, Inc., Elkhart, IN (US)

(21) Appl. No.: 13/441,689

(22) Filed: Apr. 6, 2012

Related U.S. Application Data
(60) Provisional application No. 61/473,070, filed on Apr. 7, 2011.

(51) Int. Cl. B60R 22/343

(52) U.S. Cl. 280/806

(57) ABSTRACT

Personal restraint systems for use in recreational utility vehicles (RUVs) are disclosed herein. A personal restraint system configured in accordance with one embodiment of the disclosure includes a web configured to extend around an occupant and a locking retractor having a motorized spool. A control module is electrically coupled to the locking retractor and the motorized spool is operably coupled to the web. A sensor is electrically coupled to the control module and is configured to detect dynamic characteristics of the RUV. In one embodiment, the sensor detects acceleration events that indicate a level of ride quality and the locking retractor adjusts the tension in the web based on the level of ride quality.

### CROSS-REFERENCE TO RELATED APPLICATION

This patent application claims the benefit under 35 U.S.C. §119 of U.S. Provisional Patent Application No. 61/473,070, filed Apr. 7, 2011, the disclosure of which is incorporated herein by reference in its entirety.

### TECHNICAL FIELD

The following disclosure relates generally to personal restraint systems for use in vehicles and, more particularly, to personal restraint systems for use in off-road recreational utility vehicles (RUVs).

### BACKGROUND

Various types of seat belt systems are known for restraining an occupant in an RUV. Conventional seat belt systems for RUVs typically include either a lap belt, a lap belt with attachable shoulder harness, or a five point harness. Some RUVs utilize a three point seat belt system that is substantially similar to those found in automobiles. These systems typically include an elongate web forming a lap belt and a shoulder belt. The web typically carries a connector that can slide between the lap and shoulder portions of the belt and be releasably attached to a buckle anchored to the floor of the RUV on the inboard side of the seat base. The opposite end of the shoulder belt typically passes through an upper D-ring or guide attached to the seat, sidewall or pillar on the outboard side of the seat, and can be affixed to a retractor or an anchor on the sidewall or pillar. The opposite end of the lap belt typically attaches to an anchor plate fixed to the floor or seat on the outboard side.

Conventional designs for three point seat belt systems in RUVs do not provide a large range of adjustment to accommodate a wide range of passenger sizes. Specifically, conventional systems may leave gaps between the belt and very small passengers, or may be overly tight for very large passengers. Additionally, conventional three point systems in RUVs may be uncomfortable when worn over rough terrain at high speeds.

### BRIEF DESCRIPTION OF THE DRAWINGS

FIG. 1 is an isometric view of an adjustable personal restraint system configured in accordance with an embodiment of the disclosure.

FIG. 2 is a partially schematic isometric view of an automatically adjusting personal restraint system configured in accordance with another embodiment of the disclosure.

FIG. 3 is an isometric view of a fluid dampened personal restraint system configured in accordance with a further embodiment of the disclosure.

FIG. 4 is an isometric view of a dual Emergency Locking Retractor fluid dampened personal restraint system configured in accordance with another embodiment of the disclosure.

FIG. 5A is an isometric view of a load limiting personal restraint system configured in accordance with a further embodiment of the disclosure.

FIGS. 5B-5F are isometric views of various load limiting components configured in accordance with embodiments of the disclosure.

FIGS. 6-9B are global isometric views of load distributing personal restraint systems configured in accordance with embodiments of the disclosure.

FIGS. 10A and B are global isometric views of an automatically activated inflatable personal restraint system configured in accordance with an embodiment of the disclosure.

FIGS. 11A and B are global isometric views of a manually activated inflatable personal restraint system configured in accordance with another embodiment of the disclosure.

FIGS. 12A and B are global side views of an air curtain personal restraint system configured in accordance with a further embodiment of the disclosure.

FIG. 13 is an isometric view of a quick connector configured in accordance with a further embodiment of the present disclosure.

### DETAILED DESCRIPTION

The present disclosure is directed generally to apparatuses, devices and associated methods for restraining occupants in RUVs. A three point seat belt system for an RUV configured in accordance with one embodiment of the disclosure, for example, provides for manual adjustment of all three mounting points. The adjustability of the three mounting points provides a secure and comfortable restraint for a large range of passenger sizes. In another embodiment, a three point seat belt system includes automatic adjustment of all three mounting points based on a determination of an occupant's weight.

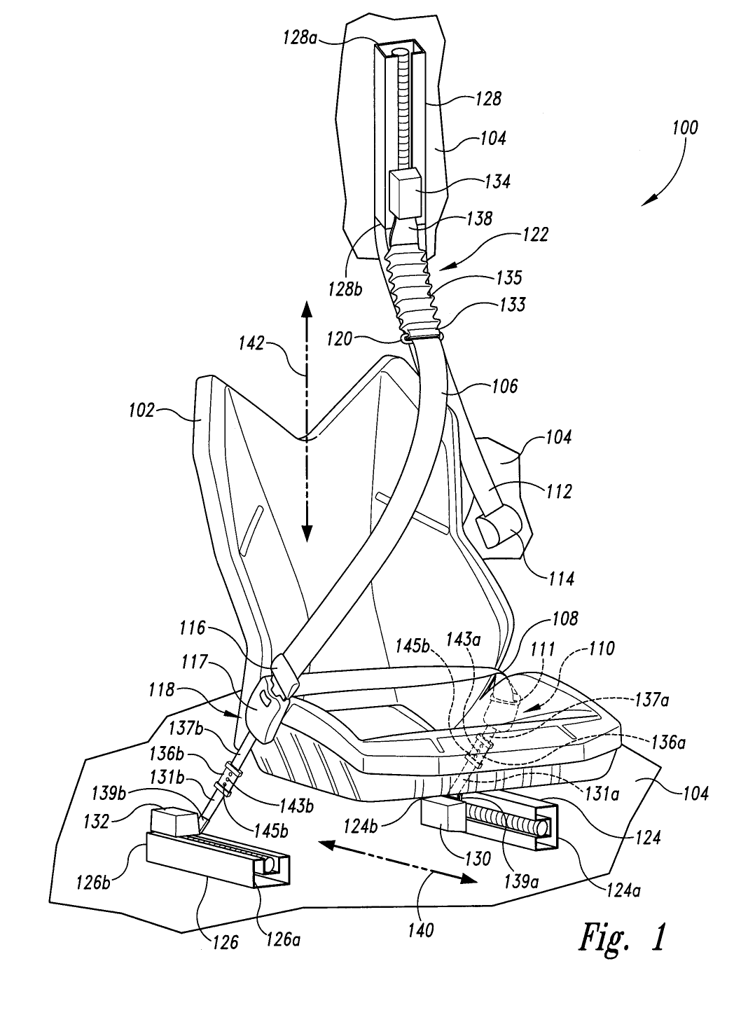

Several details of well-known structures and systems often associated with seat belt systems and other personal restraint systems are not set forth in the following description to avoid unnecessarily obscuring embodiments of the disclosure. Moreover, although the following disclosure sets forth several embodiments of the invention, other embodiments can have different configurations, arrangements, and/or components than those described herein without departing from the spirit or scope of the present disclosure. Other embodiments, for example, may have additional elements, or they may lack one or more of the elements described below with reference to FIGS. 1-13.

Many of the details, dimensions, angles and other features shown in the Figures are merely illustrative of particular embodiments of the disclosure. Accordingly, other embodiments can have other details, dimensions, angles and features without departing from the spirit or scope of the present disclosure. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refer to the Figure in which that element is first introduced. Element 110, for example, is first introduced and discussed with reference to FIG. 1.

FIG. 1 is an isometric view of an adjustable personal restraint system 100 (“restraint system 100”) configured in accordance with an embodiment of the disclosure. In the illustrated embodiment, the restraint system 100 is used with an occupant seat 102 in a vehicle 104, such as an RUV and/or other off-road vehicle. In other embodiments, the restraint system 100 may be used with other vehicles, such as cars, trucks, or other land vehicles, as well as aircraft, watercraft, etc.

In the illustrated embodiment, the restraint system 100 includes an elongate and flexible web 106 (e.g., a conventional seat belt web) having a first end portion 108 fixedly attached to an adjustable anchor mount 110 on a floor of the vehicle 104 adjacent a base of the seat 102, and a second end portion 112 wound onto a web retractor 114 fixedly attached to a sidewall or roll bar of the vehicle adjacent a back of the seat 102. A belt connector 116 is slidably coupled to the web 106. The belt connector 116 includes a tongue (e.g., a metal tongue; not shown) that releasably engages a buckle 117 anchored to the floor of the vehicle 104 via an adjustable buckle mount 118 positioned opposite the adjustable anchor mount 110. The buckle 117 can be a conventional seat belt buckle having a button or other actuator for releasing the belt connector 116 when the occupant wishes to depart the vehicle.

The flexible web 106 slidably passes through a D-ring or guide 120 of an adjustable shoulder mount 122 before extending downward into the web retractor 114. In the illustrated embodiment, the web retractor 114 can be a conventional web retractor having a spring-loaded reel or spool that winds the web 106 into the retractor 114 and maintains tension on the web 106 when it is buckled around an occupant. Alternatively, the web retractor 114 can include a fluid dampener, as discussed further below. In either case, the web retractor 114 can employ a locking feature that prevents payout of the web when a sudden acceleration of the web payout occurs, such as during an accident or other rapid deceleration.

In the illustrated embodiment, the adjustable anchor mount 110 includes an anchor 111 attached to a distal end 137a of a first connecting arm 131a. A proximal end 139a of the first connecting arm 131a is attached to a first guide coupling 130. The first guide coupling 130 is slidably received by a guide rail 124 fixedly attached to the floor of the vehicle 104. The buckle 117 is attached to a distal end 137b of a second connecting arm 131b. A proximal end 139b of the second connecting arm 131b is attached to a second guide coupling 132. The second guide coupling 132 is slidably received by a second guide rail 126. The shoulder mount guide 120 is fixedly attached to a distal end 133 of a support 135. A proximal end 138 of the support 135 is attached to a third guide coupling 134. The third guide coupling 134 is slidably received in a third guide rail 128.

The guide rails 124 and 126 include forward portions 124a and 126a, respectively, and rearward portions 124b and 126b, respectively. The guide rail 128 includes an upper portion 128a and a lower portion 128b. The guide rails 124 and 126 are mounted to the floor of the vehicle 104 at an angle relative to a fore and aft axis 140 of the vehicle 104. More specifically, the guide rails 124 and 126 are not parallel to the axis 140 or to each other, and the forward portions 124a and 126a are further away from each other than rearward portions 124b and 126b. Accordingly, movement of the guide couplings 130 and 132 forward along the corresponding guide rails 124 and 126 results in the guide couplings 130 and 132 and the corresponding anchor and buckle moving further away from each other. Conversely, movement of the guide couplings 130 and 132 rearward moves the guide couplings and the corresponding anchor and buckle closer to each other.

Restraint systems configured in accordance with the present disclosure can include various mechanical devices for adjusting the distance between the lengths of the connecting arms 131a and 131b. In the illustrated embodiment, for example, the connecting arms 131a and 131b include corresponding length adjusters 136a and 136b, respectively. The length adjusters 136 can include overlapping metal bars with a series of openings 143a and 143b. Securing pins 145a and 145b lock the respective connecting arms 131 at a fixed length. In this manner, anchor 111 and buckle 117 can be further adjusted between lower and upper positions. In other embodiments, the connecting arms 131 can include other mechanical features known in the art for adjusting the length thereof.

In the illustrated embodiment, the guide rail 128 is mounted on a pillar, roll bar, or wall of the vehicle at an angle relative to a vertical axis 142 of the seat 102. More specifically, in this embodiment, the upper portion 128a is more distant from the vertical axis 142 while the lower portion 128b is closer to the vertical axis 142. Accordingly, upward movement of the guide coupling 134 along the guide rail 128 results in the guide coupling 134 and the corresponding shoulder mount guide 120 moving between an upper, rearward and outward position, and a lower, forward and inward position.

The restraint system 100 can be used to restrain an occupant (not shown) in the seat 102 in the event of a rapid deceleration event, such as an accident. The restraint system 100 can also provide certain advantages over conventional restraint systems. For example, as discussed in detail above, the anchor 111, the buckle 117, and the shoulder mount guide 120 can be individually positioned within a wide range of adjustments to accommodate a large range of passenger sizes. The ability to individually position the anchor 111, the buckle 117 and the shoulder mount guide 122 provides a more comfortable fit for the occupant.

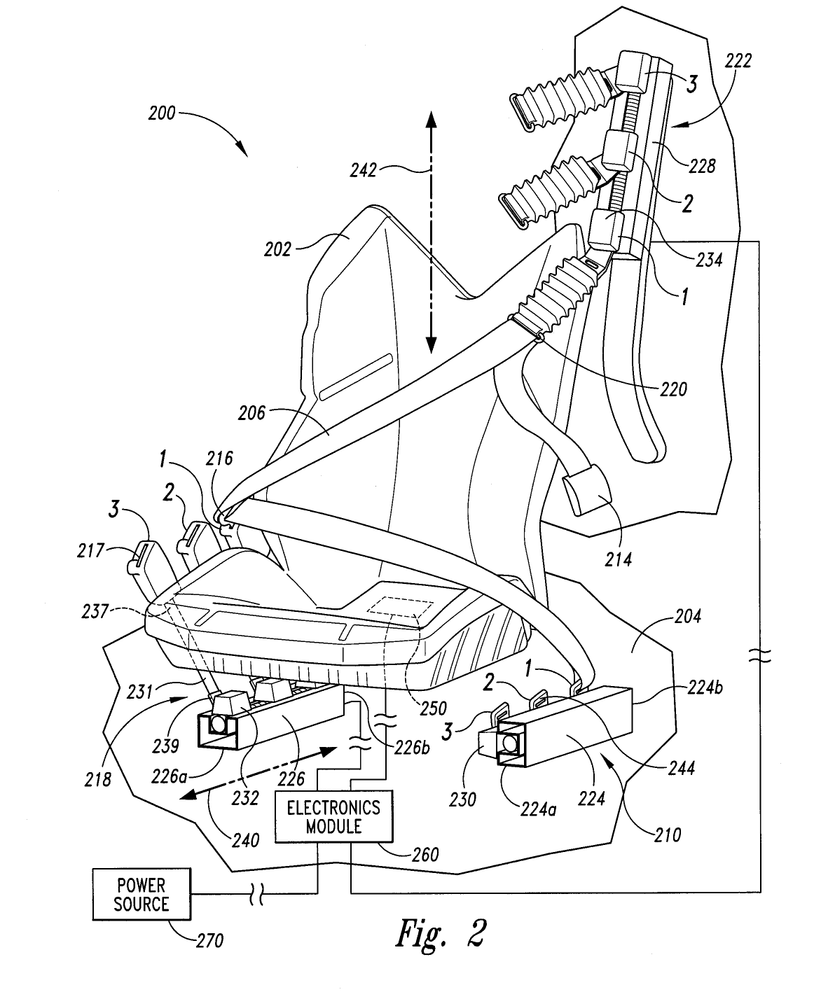

FIG. 2 is a partially schematic isometric view of an automatically adjusting personal restraint system 200 configured in accordance with another embodiment of the present disclosure. The restraint system 200 is similar to the restraint system 100 in many respects. The restraint system 200, for example, includes an elongate and flexible web 206, a web retractor 214, and a belt connector 216. This embodiment, however, includes an automatically adjusting anchor mount 210, an automatically adjusting buckle mount 218, and an automatically adjusting shoulder mount 222.

In the illustrated embodiment, the anchor mount 210, the buckle mount 218, and the shoulder mount 222 include corresponding guide rails 224, 226 and 228, respectively. The guide rails 224 and 226 include forward portions 224a and 226a, respectively, and rearward portions 224b and 226b, respectively. The guide rails 224, 226 and 228 further include electric motors (not shown) and internal gear systems (not shown), e.g., worm gears or rack and pinion gears. The electric motors and gear systems provide for linear motion of guide couplings 230, 232, and 234 back and forth in the corresponding guide rails 224, 226, and 228, respectively. A proximal end 239 of a connecting arm 231 is attached to the coupling 232, while the coupling 230 carries an attached anchor 244. Additionally, a buckle 217 is attached to a distal end 237 of the connecting arm 231.

In the illustrated embodiment, the restraint system 200 further includes a pressure or weight sensor 250 (shown in dashed lines) that produces a signal that corresponds to the weight of an occupant (not shown). For example, the sensor 250 can be a piezoelectric sensor, a strain gauge, and/or other suitable weight sensor known in the art. The sensor 250 is electrically connected to an electronics module 260, which includes a processor that executes computer readable instructions stored on memory (not shown). The electronics module 260 can receive power from a vehicle electrical power source 270, e.g., a battery or other source.

The guide rails 224, 226, and 228 of this embodiment are mounted in a similar manner to the guide rails described above with respect to the restraint system 100. That is, the guide rails 224 and 226 are mounted at an angle relative to a fore and aft axis 240 of the vehicle. However, the guide rails 224 and 226 are also mounted at an angle relative to a floor 204 of the vehicle. More specifically, the guide rails 224 and 226 are not parallel to the floor 204, and the forward portions 224a and 226a are further from the floor than the rearward portions 224b and 226b. Accordingly, in this embodiment, the buckle 217 and the anchor 244 move between a lower, rearward and inward position 1 and an upper, forward and outward position 3. Similar to the manually adjustable shoulder mount 122, the automatically adjusting shoulder mount 222 is mounted at an angle to a vertical axis 242 of the seat 202. The guide coupling 234 carries a shoulder mount guide 220 that moves between a lower, forward and inward position 1, and an upper, rearward and outward position 3.

In operation, an algorithm stored in the memory of the electronics module 260 determines whether the signal from the sensor 250 necessitates automatic movement of one or more of the anchor mount 210, buckle mount 218, or shoulder mount 222. By way of example, the automatically adjusting anchor mount 210, buckle mount 218 and shoulder mount 222 can be set up to provide for three different positions that correspond to different weight ranges. For smaller occupants that weigh less than, e.g., 90 pounds, position 1 can be used. For occupants greater than or equal to 90 pounds, but less than, e.g., 200 pounds, position 2 can be used. For occupants greater than or equal to 200 pounds, position 3 can be used. Assuming, for example, that a previous occupant was a 100 pound person, the guide couplings 230 and 232 would be in rearward, inward, and lower positions (position 1), and the guide coupling 234 would be in a forward, inward, and lower position (position 1). Conversely, assuming that a 230 pound person subsequently occupied the seat 202, the signal from the sensor 250 would indicate the higher weight to the electronics module 260. The algorithm would determine that position 3 is desired, and the electronics module 260 would send signals to the motors of the guide rails 224, 226, and 228 to drive the guide couplings 230, 232, and 234 to their respective position 3.

Although the previous example involves varying the position of the guide couplings 230, 232, and 234 between three different positions for three different weight ranges, those skilled in the art will recognize that the adjustments could be set up in a multitude of ranges without deviating from the scope of the present disclosure. The adjustments could be based on a continuous range, for example, so that each incremental weight change results in an incremental adjustment of the position of the automatically adjusting mounts.

In certain embodiments, the adjustments of the restraint system 100 and the restraint system 200 described above can be used to accommodate a much larger range of passenger sizes than conventional RUV passenger restraint systems. A restraint system configured in accordance with the present disclosure, for example, can adapt to fit occupants whose weights range from that of a 5th percentile female to a 95th percentile male. Accordingly, the systems of the present disclosure comfortably accommodate a broader range of occupants than what may be available from conventional systems.

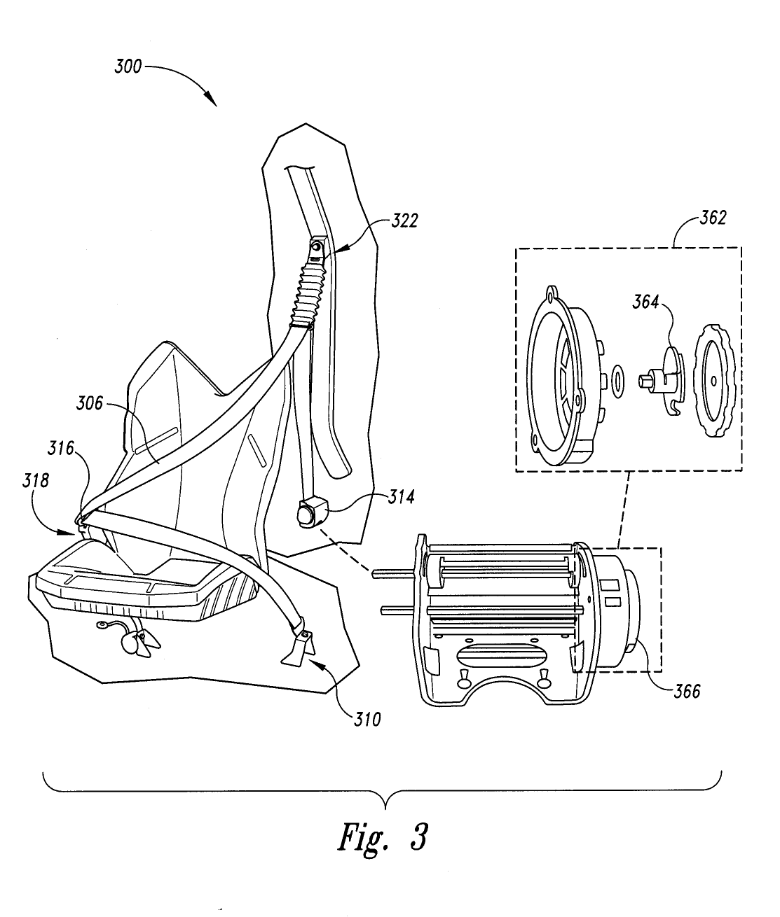

FIG. 3 is an isometric view of a fluid dampened personal restraint system 300 configured in accordance with another embodiment of the present disclosure. The restraint system 300 includes a fluid dampened emergency locking retractor (ELR) 314. The operating environment of RUVs is particularly suited to the enhanced characteristics of ELRs incorporating fluid dampening.

As with the restraint systems 100 and 200 described above with reference to FIGS. 1 and 2, the fluid dampened personal restraint system 300 includes an elongate and flexible web 306, a belt connector 316, an anchor mount 310, a buckle mount 318, and a shoulder mount 322. The ELR 314 includes an integral fluid dampener 362 having an impeller 364 that is connected to an axle (not shown) of a spool (not shown), and is contained in a fluid filled enclosure 366. The web 306 is wound around the spool within the ELR 314.

In operation, when the web is being retracted or payed out, the spool and the attached impeller 364 spin. The spinning motion of the impeller 364 in the fluid filled enclosure 366 is dampened by the hydraulic forces of the fluid. This dampening acts to moderate the rate at which the web 306 is either retracted or payed out. In the event of an engagement of the locking feature of the ELR 314, the fluid dampener 362 moderates the transition from payout to a locked condition. By slowing the payout of the web 306, the transition to a locked state is accompanied by a smaller overall force.

At high speeds and on rough surfaces, the dampening effect of the fluid dampened ELR 314 provides for improved occupant comfort in an RUV. As the RUV is subjected to acceleration events, the forces transmitted to an occupant through the restraint system 300 are minimized.

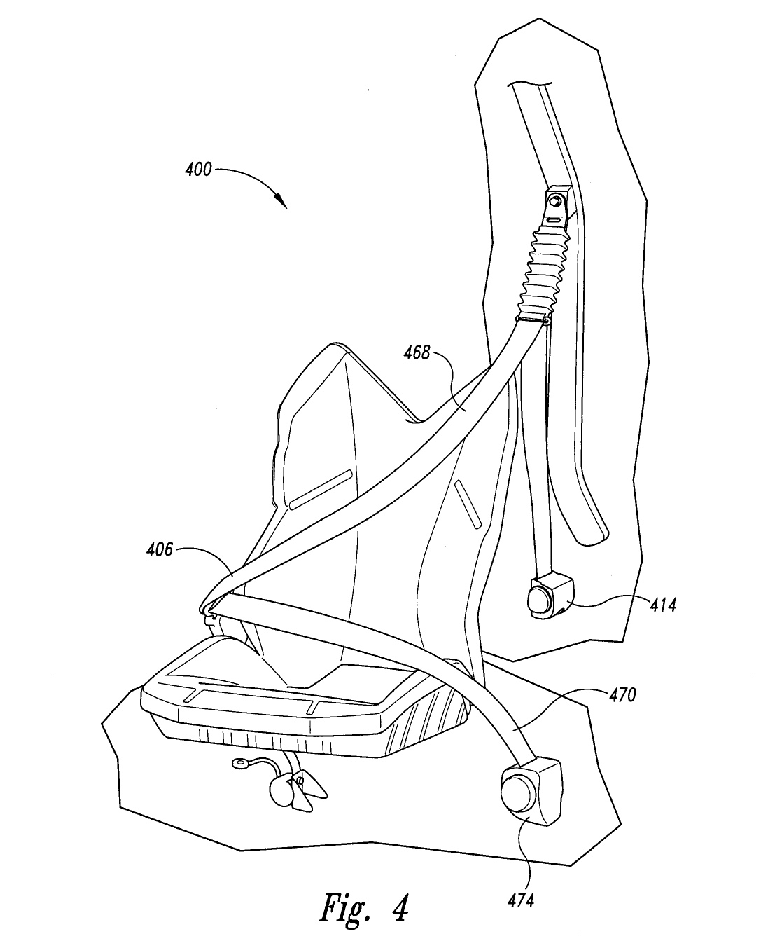

FIG. 4 is an isometric view of a dual ELR fluid dampened personal restraint system 400 configured in accordance with a further embodiment of the present disclosure. The restraint system 400 is similar in many respects to the restraint system 300, but provides additional features. The restraint system 400 includes a standard ELR 474 and a fluid dampened ELR 414. This design allows for separate lock/unlock and retraction force properties for a shoulder belt portion 468 and a lap belt portion 470 of web 406. The fluid dampened ELR 414, for example, may be configured with a relatively strong retraction spring, while the ELR 474 is configured with a relatively weaker retraction spring. This configuration prevents slack in both the lap belt portion 470 and the shoulder belt portion 468 of the web 406, but also helps prevent an occupant from experiencing the discomfort caused by the relatively stronger retraction force of the spring in the fluid dampened ELR 414. As discussed above, the fluid dampened ELR 414 prevents the web 406 from being retracted at high speeds, protecting the occupant from the discomfort of the relatively high spring force of the fluid dampened ELR 414.

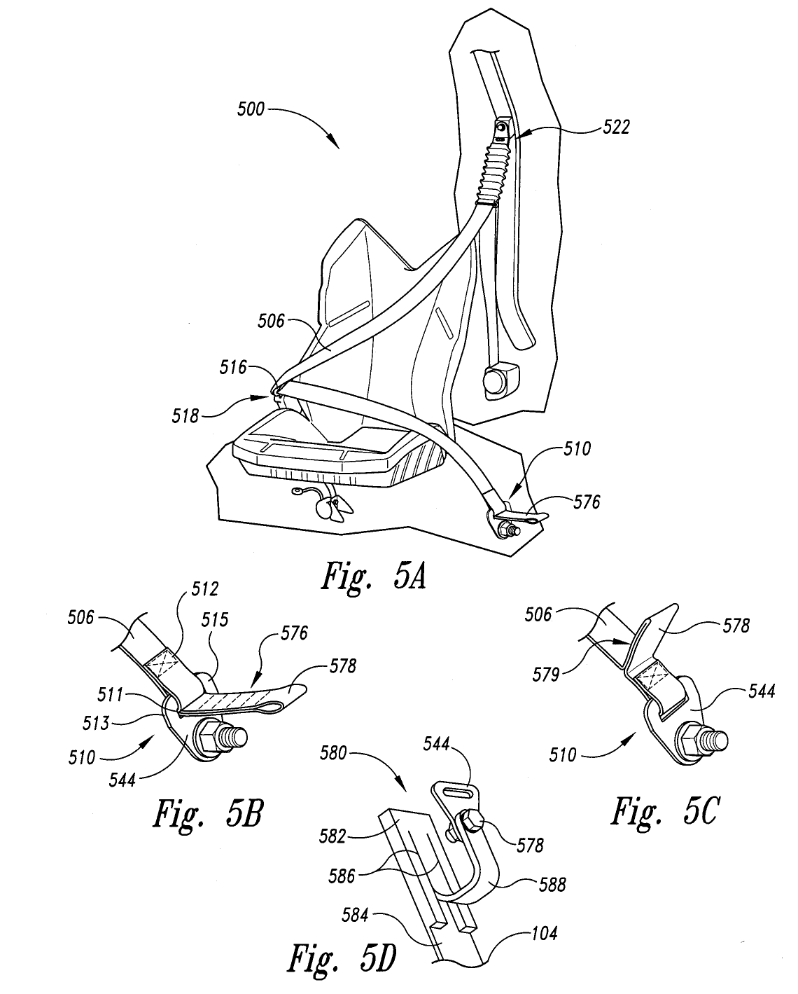

FIGS. 5A-5F illustrate several embodiments of various features of a load limiting personal restraint system 500. FIG. 5A is an isometric view of the restraint system 500. As with previous embodiments, the restraint system 500 includes an elongate and flexible web 506, a belt connector 516, an anchor mount 510, a buckle mount 518, and a shoulder mount 522. The restraint system 500, however, is configured with load limiting features such as rip stitching 576 (FIGS. 5A and 5B). The embodiments of FIGS. 5B-5F provide other load limiting designs and features that minimize the impact force experienced by an occupant of an RUV in a collision or accident.

FIG. 5B is an isometric view of a rip stitching load limiting feature. An end portion 512 of the web 506 is passed through an opening 511 in an anchor 544 from a first side 513 to a second side 515. The end portion 512 is folded back on itself, and over the anchor 544 to form a web loop 578. The end portion 512 is stitched to the web 506 on the first side 513 of the anchor mount 510. A section of the loop 578 on the second side 515 of the opening 511 is compressed to be flat, and the rip stitching 576 is sewn across the web 506. In the event of a high impact collision or accident, an RUV occupant is subjected to a lower maximum force due to a regulated delivery of the force through the rip stitching 576. Depending on the severity of the impact, some or all of the rip stitching 576 will tear, thereby providing a stepped delivery of the impact forces through the web 506.

FIG. 5C is an isometric view of tear webbing 579 configured in accordance with a further embodiment of the disclosure. The web 506 is folded into a loop 578 and the interior surfaces (not shown) of the loop 578 are affixed to each other. The surfaces may be affixed in several manners, including: stitching (similar to the rip stitching 576 of the previous embodiment); adhesive materials, e.g., glues; or webbing that is woven into a loop with tear elements running between the opposite interior faces. Tear elements are described in U.S. Pat. No. 7,815,013 issued to Griffith, which is herein incorporated in its entirety by reference. Similar to rip stitching 576, the tear webbing 579 ensures a lower maximum force is transmitted to the occupant in the event of a collision or accident.

FIG. 5D is an isometric view of a banana peel mount 580 configured in accordance with another embodiment of the present disclosure. The banana peel mount 580 may be used as a component of anchor mount 510 or buckle mount 518. A lower end 584 of a metal bar 582 is attached to the vehicle 104. The metal bar 582 includes slits 586 and a U-shaped tab 588. A fastener 578 connects the U-shaped tab 588 to the anchor 544. Alternatively, a buckle (not shown) may be used in place of the anchor 544 for mounting on the opposite side of a seat (not shown). In the event of a collision or accident that imparts high stress loads on the banana peel mount 580, the U-shaped tab 588 will move upward, away from the vehicle 104, and peel more of the U-shaped tab 588 away from the slits 586. Similar to the tear webbing 579 and the rip stitching 576, the banana peel mount 580 limits the impact forces of a collision or accident by gradually imparting the force as the U-shaped tab 588 peels upward.

FIG. 5E is an isometric view of a load limiting banana peel ELR 590 configured in accordance with a further embodiment of the present disclosure. Similar to the banana peel mount 580, the ELR 590 includes a U-shaped tab 592 and slits 587. The U-shaped tab 592 includes openings 593a and 593b. Fasteners (not shown) are inserted into the openings 593 to attach the ELR 590 to a vehicle (not shown). In the event of an impact or collision, the U-shaped tab 592 peels away from the slits 587 and limits the maximum impact force by gradually imparting the forces.

FIG. 5F is an isometric view of a load limiting ELR 594 that may be utilized in a personal restraint system configured in accordance with a further embodiment of the present disclosure. The load limiting ELR 594 includes a twistable axle (not shown) that is connected to a spool (not shown) containing a portion of the web 506. The twistable axle has a torsional rigidity that prevents it from twisting until a significant load is experienced. In the event of an impact causing the load to overcome the torsional rigidity of the axle, the web 506 pays out in a limited fashion, even if the ELR 594 is locked. This additional pay out limits the force on the occupant when the impact occurs.

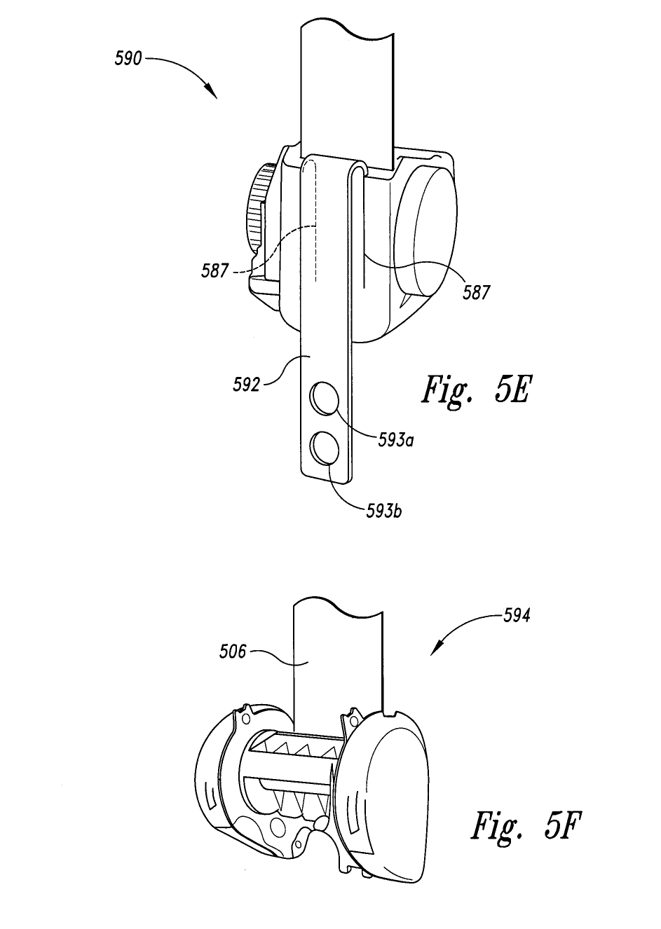

FIGS. 6-9B are global isometric views of load distributing personal restraint systems configured in accordance with embodiments of the present disclosure. FIG. 6 is a global isometric view of an expanding restraint system 600 that is generally similar in structure and function to the previously described restraint systems of this disclosure. The restraint system 600, however, includes an expanding web 606. Under a no load condition, the expanding web 606 has a first width 608. In the event of a collision or impact, the expanding web 606 expands at points where high loads can occur to a greater second width 610. The greater second width 610 can provide a larger surface area of the web 606 to restrain an occupant 612 in a collision. Accordingly, the forces exerted by the web 606 on the occupant 612 are not as highly localized, and the occupant 612 is less likely to suffer injury or harm.

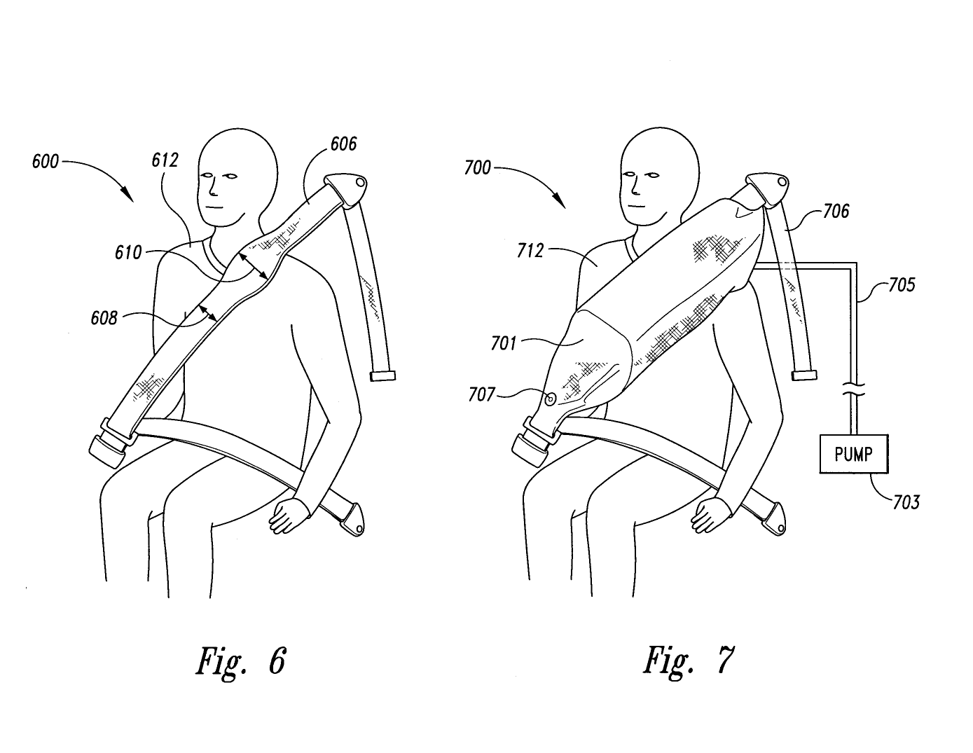

FIG. 7 is a global isometric view of an inflatable personal restraint system 700 configured in accordance with a further embodiment of the disclosure. A web 706 includes an inflatable airbag or air bladder 701. A pump 703 is connected to the air bladder 701 through a tube 705. The pump 703 may be a manually operated hand pump or an electrically operated pump. The air bladder 701 further includes a release valve 707. The compressibility of the air bladder 701 decreases as more air is introduced from the pump 707 and the pressure inside the air bladder 701 accordingly increases. Additionally, the volume of the air bladder 701 increases as more air is introduced. At a certain pressure, however, the addition of more air results in limited increases in volume as the maximum volume of the air bladder 701 is approached. The occupant 712 can determine the optimum or near optimum pressure and volume of the air bladder 701 and adjust these parameters by operating the pump 703 and the release valve 707 to either add or remove air from the air bladder 701. The large surface area and compressibility of the air bladder 701 provide for a distribution and minimization of forces experienced by the occupant 712. Accordingly, the inflatable belt personal restraint system 700 provides for a more comfortable experience for an RUV occupant by cushioning the impact forces experienced through the web 706.

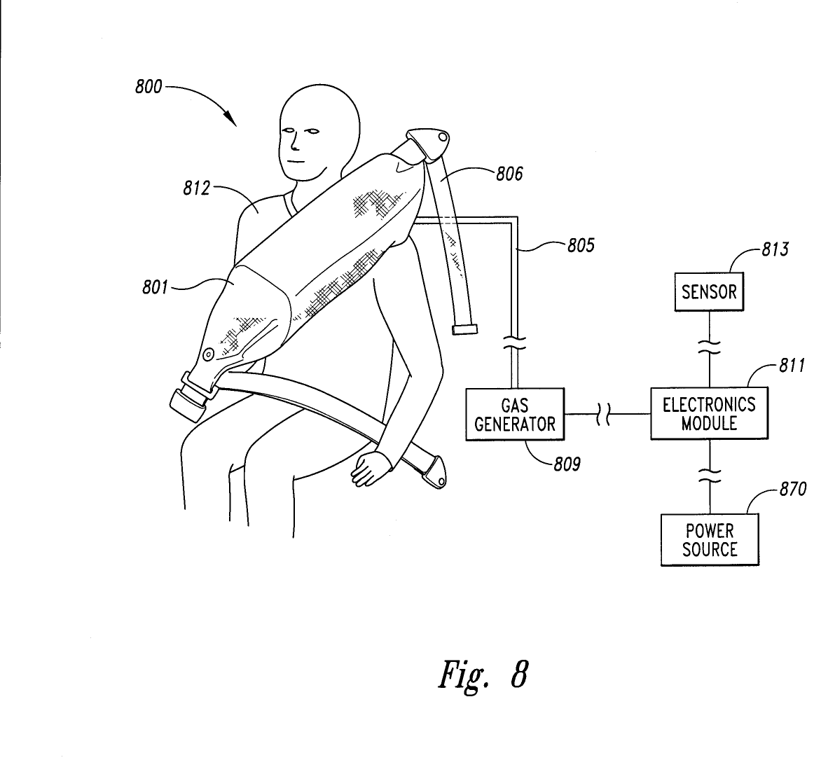

FIG. 8 is a global isometric view of a rapid inflating personal restraint system 800 configured in accordance with a further embodiment of the disclosure. Similar to the restraint system 700, the restraint system 800 includes an inflatable bladder 801 that is attached to a web 806 and a tube 805. Rather than a pump, however, the present embodiment can include a gas storage device or a gas generator 809 that fills the air bladder 801 in response to a dynamic event, such as an accident or collision. The gas generator 809 is electrically connected to an electronics module 811 which includes a processor and memory (not shown). The electronics module 811 is electrically connected to a sensor 813 and receives electrical power from a vehicle electrical power source 870, e.g., a battery. The sensor 813 can be an accelerometer or other differential motion detector for sensing, e.g., a rapid deceleration event. The electronics module 811 processes signals from the sensor 813. When a collision or other impact causes a force above a predetermined limit, the electronics module 811 receives the resultant signal from the sensor 813 and sends a corresponding signal to initiate the gas generator 809. The initiation of the gas generator 809 produces a large volume of gas that travels through the tube 805 and inflates the air bladder 801.

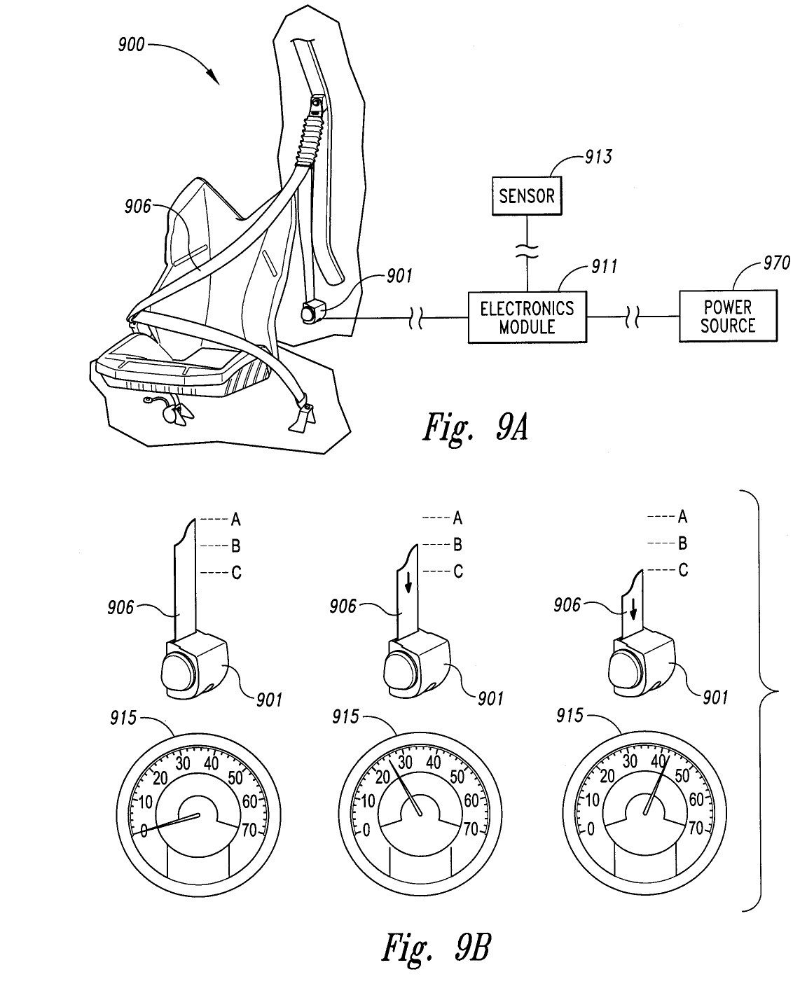

FIGS. 9A-9B are global isometric views of an electronic ELR personal restraint system 900 configured in accordance with further embodiments of the present disclosure. The restraint system 900 includes an electronic ELR 901 that can be utilized in multiple configurations. As shown in FIG. 9A, the ELR 901 is electrically connected to an electronics module 911. The electronics module 911 is electrically connected to a sensor 913 and a vehicle electrical power source 970, e.g., a battery. The sensor 913 can be a speed sensor, an accelerometer, a gyroscopic sensor, a speedometer, etc. Additionally, although the sensor 913 and the electronics module 911 are shown separate from the ELR 901, those skilled in the art will recognize that it is within the scope of the present disclosure for these components to alternatively be integral with the ELR 901.

The ELR 901 can employ electronic locking capabilities, a motorized spool, multi-stage retraction springs, and/or additional features. In the illustrated embodiment, the electronics module 911 uses data from the sensor 913 to adjust the operation of the electronic ELR 901. It is within the scope of the present disclosure, however, to include more than one sensor. A gyroscopic sensor, for example, could be utilized in addition to a speedometer. In this manner, the restraint system 900 could adjust the function of the ELR 901 based on the tilt of a vehicle.

FIG. 9B further illustrates the operation of an embodiment of the restraint system 900. A speedometer 915 is employed as the previously discussed sensor 913. By way of example, the restraint system 900 can be set up to provide for three different tension positions that correspond to different speeds. A first tension position A for speeds less than or equal to, e.g., 20 miles per hour; a second tension position B for speeds greater than 20 miles per hour but less than or equal to, e.g., 35 miles per hour; and a third tension position C for speeds greater than 35 miles per hour. While the vehicle is motionless, a web 906 is initially in position A and extended around an occupant (not shown) with minimal tension, and the ELR 901 is unlocked. When the vehicle speed reaches 20 miles per hour, the electronics module 911 receives a signal from the speedometer 915, and sends a corresponding signal to the ELR 901 to increase the tension in the web 906 and lock the ELR 901. A motorized spool (not shown) retrieves a portion of the web 906, moving the web 906 to position B and increasing the tension, and a solenoid (not shown) locks the ELR 901. As the vehicle continues to increase speed and reaches 35 miles per hour, the electronics module 911 receives another signal from the speedometer 915 and sends a corresponding signal to the ELR 901 to further increase the tension in the web 906. The motorized spool retrieves another portion of the web 906, moving the web 906 to position C and further increasing the tension. When the vehicle slows to below 35 miles per hour, the electronics module 911 receives a signal from the speedometer 915 and sends a corresponding signal to the ELR 901 to decrease tension in the web 906. The motorized spool pays out a portion of the web 906, moving the web 906 to position B and decreasing the tension. When the speed drops below 20 miles per hour, the electronics module 911 receives a signal from the speedometer 915 and sends a corresponding signal to the ELR 901 to decrease the tension and unlock the ELR 901. The solenoid unlocks the ELR 901 and the motorized spool pays out a portion of the web 906, moving the web 906 to position A.

Although the illustrated embodiment varies the tension and position of the web 906 between three different settings for three different speed ranges, those skilled in the art will recognize that the adjustments could be set up in a multitude of ranges without deviating from the scope of the present disclosure. The adjustments could be based on a continuous range, for example, so that each incremental speed change results in an incremental adjustment of the position of the motorized spool.

The tension in the web 906 can correlate to a level of ride quality for the occupant. For example, as vehicle speed increases, bumps, holes, obstacles, or other rough terrain impart larger forces to the vehicle. The higher the vehicle speed, the more force that is imparted to the vehicle and transmitted to the occupant. In the illustrated embodiment of FIG. 9B, as the vehicle speed increases the tension in the web 906 is increased. The increased tension provided at higher speeds can provide a more secure and comfortable experience for the occupant when the vehicle is traveling on rough terrain.

In other embodiments, other sensors can be used in addition to or in lieu of the speedometer 915 to provide a varying tension in the web 906 and a more secure and comfortable experience for the occupant. In one embodiment, an accelerometer can measure acceleration events that correspond to rough terrain and can provide a varying tension in the web 906. For example, when the acceleration sensor measures acceleration events during normal vehicle operation (i.e., not a crash event) that correspond to a first predetermined level of ride quality (e.g., a rough ride), the electronics module 911 can send a signal to the ELR 901 to increase the tension in the web 906. When the acceleration sensor measures acceleration events that correspond to a second predetermined level of ride quality (better than the first predetermined level, e.g., a smooth ride), the electronics module 911 can send a signal to the ELR 901 to decrease the tension in the web 906.

Similar to the speed dependent variation of the tension in the web 906 described above, the variation of the tension in the web 906 based on acceleration or ride quality can include multiple levels of ride quality, each having a corresponding tension, including a continuous range of ride qualities and corresponding tensions. As described above, the acceleration based variation of tension in the web 906 can be provided in response to acceleration events that do not involve a crash. That is, acceleration events that occur during normal vehicle operation. In other embodiments, the acceleration sensor, or other sensors, can be used to provide similar or additional features in the event of a crash.

Additionally, although FIG. 9B illustrates the usage of a motorized spool and solenoid locking, the restraint system 900 can further include a multi-stage retraction spring (not shown). The multi-stage retraction spring can be activated by the electronic module 911 to provide for differing levels of retraction force depending on signals received from the sensor 913. Speed dependent ranges, for example, as discussed above, can be used to increase the retraction force as the speed increases.

Embodiments configured in accordance with the present disclosure can encourage increased restraint system usage for RUV occupants. RUVs are often utilized in rough terrain and can experience significant forces as part of their normal use. Conventional restraint systems for RUVs can be uncomfortable in rough terrain and impart jarring forces on an occupant. These experiences can make a user less prone to utilize a conventional restraint system. By providing a more secure and comfortable experience for the occupant, the embodiments disclosed herein can reduce these effects and thereby increase usage of the restraint system.

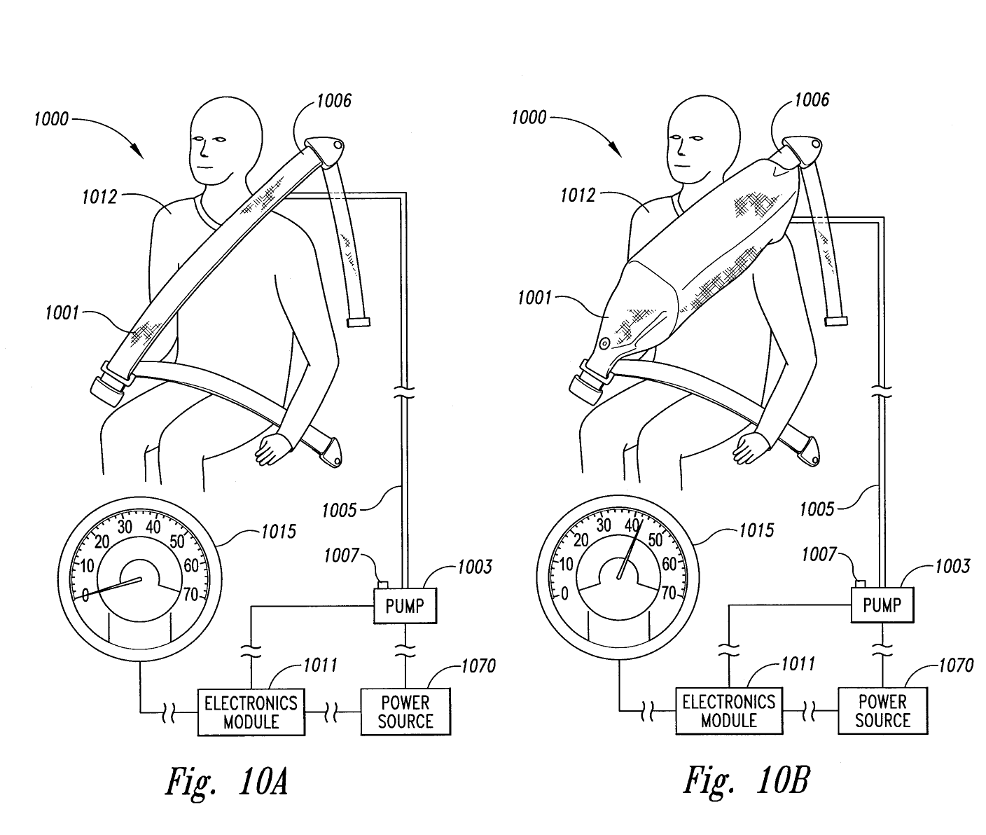

FIGS. 10A and 10B are global isometric views of an automatically activated inflatable personal restraint system 1000 configured in accordance with a further embodiment of the present disclosure. Similar to the restraint system 900, the illustrated embodiment utilizes a speedometer 1015 to adjust the operation of the personal restraint system 1000. An air bladder 1001 that is similar to the previously discussed air bladder 801 is attached to a web 1006. A pump 1003 with a release valve 1007 is connected to the air bladder 1001 through a tube 1005. The pump 1003 is electrically connected to an electronic control unit 1011 and a vehicle power source 1070, e.g., a battery. The electronic control unit 1011 is also electrically connected to the speedometer 1015.

The air bladder 1001 operates in a manner similar to the air bladder 801 of the restraint system 800. The electronic control unit, however, automatically controls inflation and deflation of the air bladder 1001 using the pump 1003 and the release valve 1007. In the illustrated embodiment, the speedometer 1015 sends a signal to the electronic control unit 1011 indicating vehicle speed. As shown in FIG. 10A, when the vehicle is motionless, the air bladder 1001 is deflated. As speed increases, as shown in FIG. 10B, the electronic control unit 1011 intermittently activates the pump 1003, adding air to the air bladder 1001 and causing the air bladder 1001 to inflate. As speed decreases, the electronic control unit 1011 intermittently activates the release valve 1007, causing air to exit the air bladder 1001.

As with the restraint systems described above that utilize sensors, the restraint system 1000 can utilize alternative or additional sensors to signal activation. Gyroscopes, accelerometers, or speed sensors, for example, can be used. Furthermore, as with the restraint system 800, the restraint system 1000 provides for a more comfortable experience for an RUV occupant 1012 by cushioning the impact forces experienced through the web 1006.

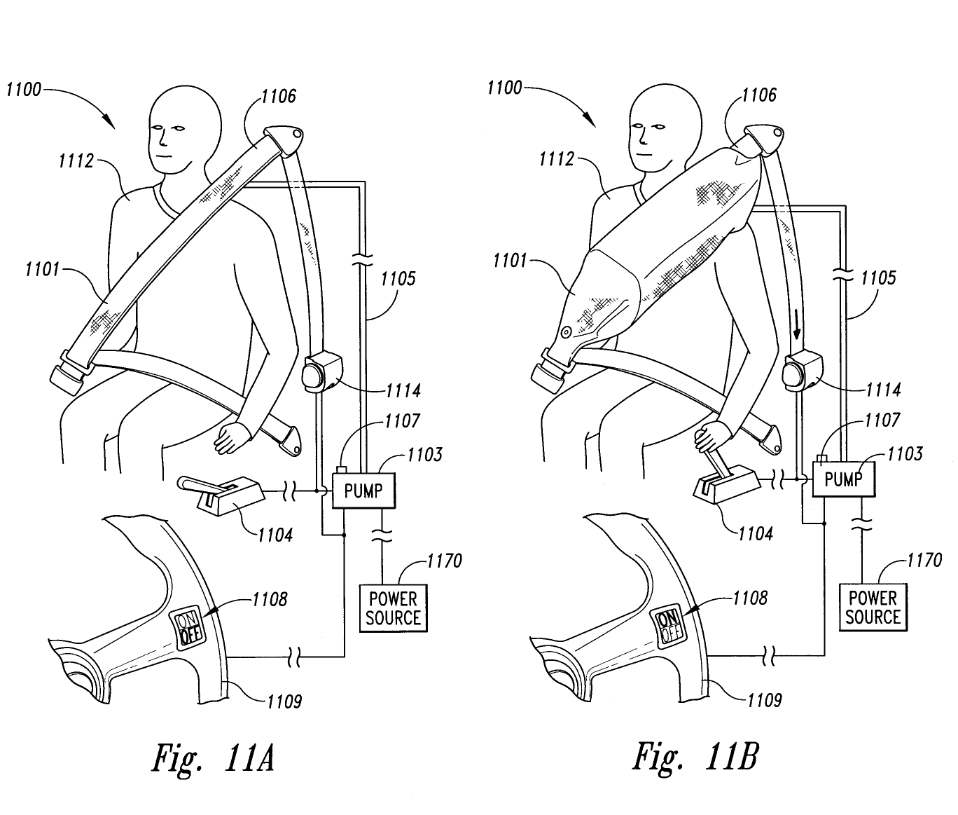

FIGS. 11A and 11B are global isometric views of a manually activated inflatable personal restraint system 1100 with an electronic ELR, configured in accordance with a further embodiment of the present disclosure. This embodiment employs features similar to the restraint systems 900 and 1000. An inflatable air bladder 1101 is attached to a web 1106. A pump 1103 with a release valve 1107 is connected to the air bladder 1101 through a tube 1105 and electrically connected to a vehicle power source 1170. The web 1106 is connected to an electronic ELR 1114. On/Off buttons 1108 are provided on a steering wheel 1109, and an activation/deactivation lever 1104 is attached to the floor of the vehicle. Although the illustrated embodiment includes the On/Off buttons 1108 and the activation/deactivation lever 1104, it is to be understood that the restraint system 1100 may be configured with other activation/deactivation devices, such as switches, toggles, etc. Additionally, it is within the scope of the present disclosure to provide a restraint system with only one of these activation/deactivation devices.

In operation, an occupant 1112 manually engages the restraint system 1100 by pulling up the lever 1104 or pressing the “On” button of the On/Off buttons 1108. A signal is sent to the ELR 1114 to retrieve a portion of the web 1106 and to lock. This increases the tension in the web 1106 and prevents additional web from paying out. Additionally, a signal is sent to the pump 1103 to run for a set period of time. The pump 1103 activates and air is pumped through the tube 1105 to fill the air bladder 1101. The occupant 1112 is provided with a snug and secure fit from the web 1106 that is cushioned by the air bladder 1101. When the occupant 1112 determines that a snug fit is no longer necessary, he lowers the lever 1104 or presses the “Off” button of the On/Off buttons 1108. The ELR 114 unlocks and pays out a portion of the web 1106 and the release valve 1101 opens, releasing air and deflating the air bladder 1101.

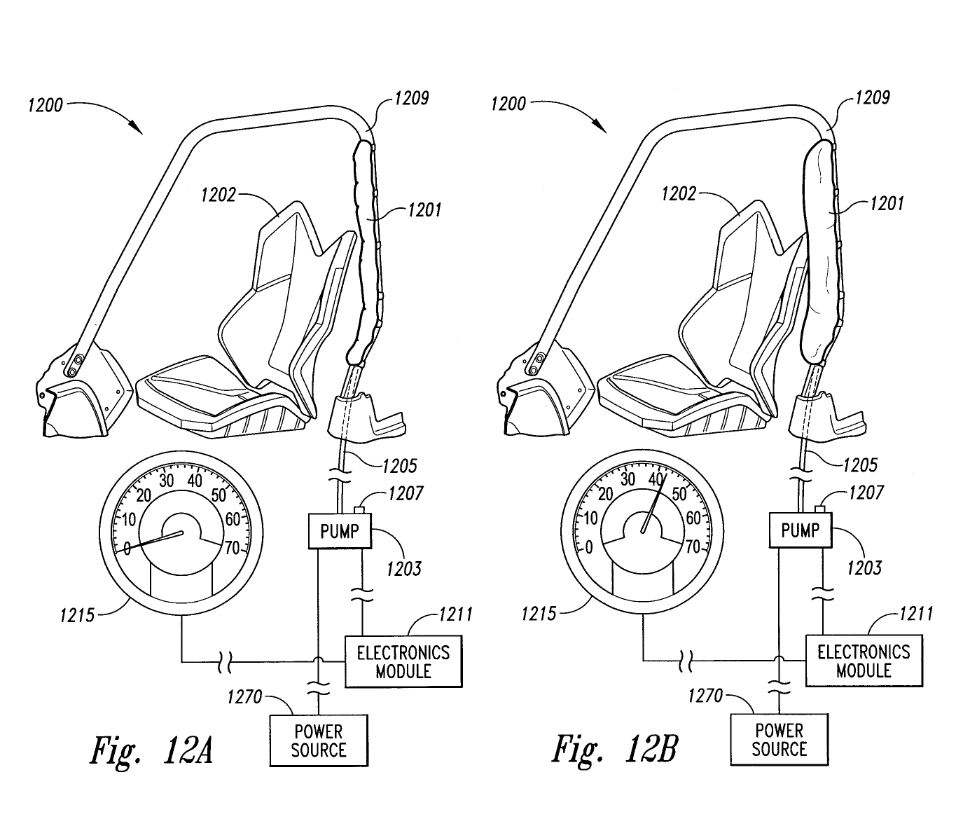

FIGS. 12A and 12B are global side views of an air curtain personal restraint system 1200 configured in accordance with a further embodiment of the present disclosure. Similar to the restraint system 1000, the illustrated embodiment utilizes a speedometer 1215 to adjust the operation of the restraint system 1200. An air curtain 1201, that is similar to the previously discussed air bladders 1001 and 1101, is attached to a roll bar 1205. A pump 1203 with a release valve 1207 is connected to the air curtain 1201 through a tube 1205. The pump 1203 is electrically connected to an electronic control unit 1211 and a vehicle power source 1270. The electronic control unit 1211 is also electrically connected to the speedometer 1215.

In operation, the speedometer 1215 sends a signal to the electronic control unit 1211 indicating vehicle speed. As shown in FIG. 12A, when the vehicle is motionless, air curtain 1201 is deflated. As speed increases, as shown in FIG. 12B, the electronic control unit 1211 intermittently activates the pump 1203, adding air to the air curtain 1201 and causing the air curtain 1201 to inflate. As speed decreases, the electronic control unit 1211 intermittently activates the release valve 1207, causing air to exit the air curtain 1201.

The air curtain 1201 operates in a manner similar to the air bladder 1001 of the restraint system 1000. The air curtain 1201, however, is used to protect and encase the rider within the RUV, rather than to minimize forces exerted by a web. Additionally, although the present embodiment illustrates a single air curtain 1201, those skilled in the art will recognize that several similar curtains can be provided on other portions of the RUV to further encase an occupant and provide for more protection in the event of an impact or collision.

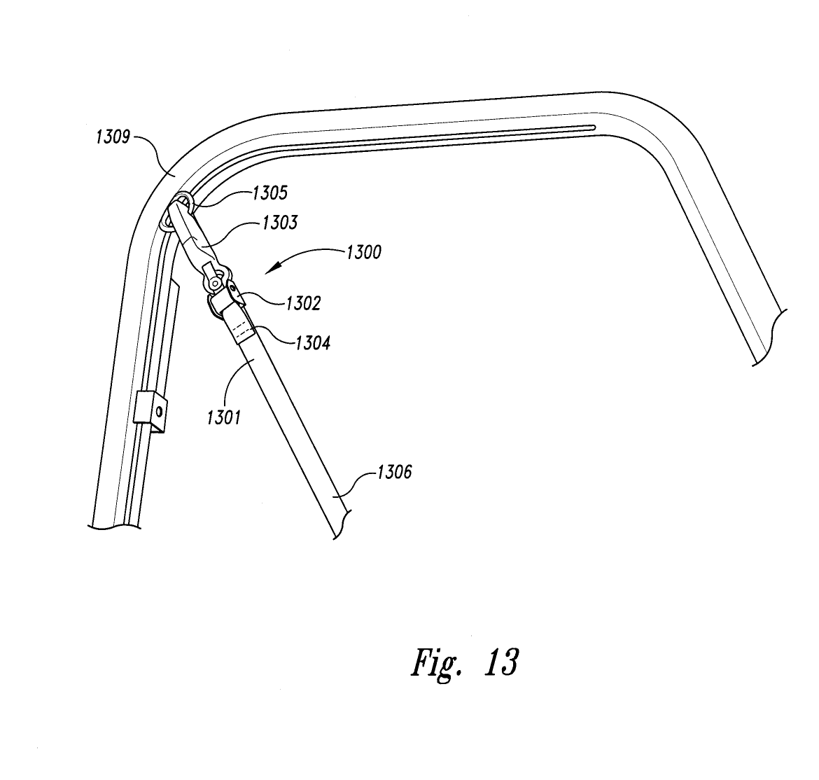

FIG. 13 is an isometric view of a quick connector 1300 configured in accordance with a further embodiment of the present disclosure. The quick connector 1300 includes a dual pivot latch assembly 1303 with an attached cam adjuster 1302. The dual pivot latch assembly 1303 can be substantially similar to the latch assemblies described in U.S. application Ser. No. 12/028,070, which is incorporated herein by reference. A first end portion 1304 of a web 1301 passes through the cam adjuster 1304. A second end portion 1306 of the web 1301 can attach to a containment web (not shown). The containment web forms a barrier to keep occupants within a seating area of an RUV. The quick connector 1300 latches to an attachment loop 1305 on a roll bar 1309 of an RUV.

A containment web with multiple quick connectors 1300 can be rapidly attached to an RUV that has multiple attachment loops 1305. A mouth of the quick connector 1300 is pushed against the attachment loop 1305 to securely attach the web 1301. The first end portion 1304 is then pulled to tighten the web 1301. This process is repeated for additional attachment points on the containment web to securely fasten the containment web to an RUV.

From the foregoing, it will be appreciated that specific embodiments of the invention have been described herein for purposes of illustration, but that various modifications may be made without deviating from the spirit and scope of the various embodiments of the invention. One skilled in the relevant art will recognize that the present technology can be practiced without one or more of the specific features or advantages of a particular embodiment. In other instances, additional features and advantages may be recognized in certain embodiments that may not be present in all embodiments of the present technology. Additionally, the described features, advantages, and characteristics of the present technology may be combined in any suitable manner in one or more embodiments. Further, while various advantages associated with certain embodiments of the invention have been described above in the context of those embodiments, other embodiments may also exhibit such advantages, and not all embodiments need necessarily exhibit such advantages to fall within the scope of the invention.

1. A personal restraint system for securing an occupant in a recreational utility vehicle (RUV), comprising:
a web configured to extend around the occupant;
a locking retractor having a motorized spool operably coupled to the web;
a control module electrically coupled to the locking retractor; and
a sensor electrically coupled to the control module, wherein the sensor is configured to detect a dynamic characteristic of the RUV and provide a first signal to the control module based on the detected characteristic, wherein the control module is configured to respond to the first signal by providing a second signal to the locking retractor, and wherein the locking retractor is configured to respond to the second signal by adjusting tension in the web.

2. The personal restraint system of claim 1 wherein the sensor comprises an accelerometer, and wherein the control module adjusts the operation of the locking retractor based on acceleration events that indicate a level of ride quality, the motorized spool retrieving a first portion of the web to increase the tension in the web in response to the acceleration events indicating a first predetermined level of ride quality, and the motorized spool paying out a second portion of the web to decrease the tension in the web in response to the acceleration events indicating a second predetermined level of ride quality, wherein the first predetermined level of ride quality corresponds to a rougher ride than the second predetermined level of ride quality.

3. The personal restraint system of claim 1 wherein the sensor comprises a speedometer and wherein the control module adjusts the operation of the locking retractor based on the vehicle's speed.

4. The personal restraint system of claim 3 wherein the control module sends the second signal to the locking retractor when the vehicle's speed increases to a first predetermined speed, the second signal causing the motorized spool to retrieve a first portion of the web, and wherein the control module sends a third signal to the locking retractor when the vehicle's speed increases to a second predetermined speed greater than the first predetermined speed, the third signal causing the motorized spool to retrieve a second portion of the web.

5. The personal restraint system of claim 3 wherein the control module sends the second signal to the locking retractor when the vehicle's speed decreases to a first predetermined speed, the second signal causing the motorized spool to pay out a first portion of the web, and wherein the control module sends a third signal to the locking retractor when the vehicle's speed decreases to a second predetermined speed less than the first predetermined speed, the third signal causing the motorized spool to pay out a second portion of the web.

6. The personal restraint system of claim 1 wherein the sensor comprises an accelerometer, and wherein the control module adjusts the operation of the locking retractor based on a tilt angle of the vehicle.

7. The personal restraint system of claim 1 wherein the locking retractor further comprises a locking solenoid configured to lock the motorized spool and prevent payout of the web.

8. A personal restraint system for securing an occupant in a recreational utility vehicle (RUV), comprising:
a web having a first end portion fixedly attached to the RUV via an anchor mount, the web configured to extend around the occupant;
an electronic emergency locking retractor operably coupled to the web, the electronic emergency locking retractor including
a motorized spool configured to retrieve a first portion of the web to increase a tension in the web and to pay out a second portion of the web to decrease the tension in the web; and
a solenoid locking mechanism configured to selectively lock the electronic emergency locking retractor; and
a sensor for detecting an operating parameter of the RUV and providing a corresponding signal to control the operation of the motorized spool and the solenoid locking mechanism.

9. The personal restraint system of claim 8 wherein the sensor comprises an accelerometer, and wherein the motorized spool increases the tension in the web upon the accelerometer sensing an acceleration above a predetermined value corresponding to a level of ride quality.

10. The personal restraint system of claim 8 wherein the sensor comprises a speed sensing device configured to determine a speed of the RUV, and wherein the motorized spool retrieves the first portion of the web upon the speed of the RUV increasing beyond a predetermined value.

11. The personal restraint system of claim 8, further comprising means for sensing a tilt angle of the RUV, and wherein upon the RUV reaching a predetermined tilt angle the motorized spool retrieves the first portion of the web and the solenoid locking mechanism locks the electronic emergency locking retractor.

12. The personal restraint system of claim 8 wherein the sensor comprises a speed sensing device configured to determine a speed of the RUV, and wherein the motorized spool increases the tension in the web for each incremental increase in the speed of the RUV, and decreases the tension in the web for each incremental decrease in the speed of the RUV.

13. The personal restraint system of claim 8 wherein the sensor is a first sensor, the first sensor comprising a speed sensing device for determining the RUV's speed, the personal restraint system further comprising a second sensor, the second sensor comprising an accelerometer for sensing acceleration events, and wherein the motorized spool increases or decreases the tension in the web based on the RUV's speed and sensed acceleration events.

14. The personal restraint system of claim 8 wherein the sensor comprises a gyroscope, wherein the gyroscope determines a tilt angle of the RUV, and wherein the motorized spool increases or decreases the tension in the web based on the tilt angle of the RUV.

15. A method for adjusting tension in a web securing an occupant in a recreational utility vehicle (RUV), the method comprising:
coupling the web to an electronic web retractor;
electronically sensing at least one operational parameter of the RUV during normal operation of the RUV; and
controlling operation of the web retractor to adjust tension in the web based on the sensed parameter.

16. The method of claim 15 wherein electronically sensing at least one operational parameter includes collecting acceleration data, and wherein controlling operation of the web retractor includes operating a motorized spool to retrieve a first portion of the web and increase the tension in the web when the acceleration data indicates a first level of ride quality, and wherein controlling operation of the web retractor further includes operating the motorized spool to pay out a second portion of the web and decrease the tension in the web when the acceleration data indicates a second level of ride quality, the first level of ride quality corresponding to a rougher ride than the second level of ride quality.

17. The method of claim 15 wherein electronically sensing at least one operational parameter includes collecting RUV tilt angle data, and wherein controlling operation of the web retractor includes operating a motorized spool to retrieve a portion of the web and increase the tension in the web.

18. The method of claim 15 wherein electronically sensing at least one operational parameter includes collecting RUV speed data, and wherein controlling operation of the web retractor includes operating a motorized spool to retrieve a portion of the web and increase the tension in the web.

19. The method of claim 15 wherein electronically sensing at least one operational parameter includes collecting data with a first sensor, the method further comprising collecting data with a second sensor, the data from the first sensor including RUV speed, the data from the second sensor including RUV acceleration events, and wherein adjusting the tension in the web includes increasing the tension in the web in response to increasing RUV speed or RUV acceleration events.

20. The method of claim 15, further comprising locking the electronic emergency locking retractor by providing a signal to a solenoid locking mechanism.
